(19) United States
(12) Patent Application Publication
(10) Pub. No.: US 2016/0247286 A1
(43) Pub. Date: Aug. 25, 2016

(54) DEPTH IMAGE GENERATION UTILIZING DEPTH INFORMATION RECONSTRUCTED FROM AN AMPLITUDE IMAGE

(71) Applicant: LSI CORPORATION, San Jose, CA (US)

(72) Inventors: Ivan L. Mazurenko, Moscow (RU); Nikola Radovanovic, Los Altos, CA (US); Denis V. Parkhomenko, Moscow (RU); Alexander B. Kholodenko, Moscow (RU); Denis V. Parfenov, Moscow (RU)

(21) Appl. No.: 14/378,119

(22) PCT Filed: Aug. 11, 2014
(86) PCT No.: PCT/US2014/050513

§ 371 Date: Aug. 12, 2014

(30) Foreign Application Priority Data
Feb. 7, 2014 (RU) 2014104445

(51) Int. Cl. G06T 7/00; G06K 9/00

(52) U.S. Cl. CPC G06T 7/0057; G06T 7/0081; G06K 9/00335

(57) ABSTRACT

An image processing system comprises an image processor having image processing circuitry and an associated memory. The image processor is configured to identify a region of interest in an amplitude image, to detect one or more relatively low gradient regions in the region of interest, to reconstruct depth information for said one or more relatively low gradient regions, to extend the reconstructed depth information beyond said one or more relatively low gradient regions to additional pixels of the region of interest, and to generate a depth image utilizing at least portions of the reconstructed depth information and the extended reconstructed depth information. The image processor in some embodiments is adapted for coupling to an active lighting image sensor, such as an infrared sensor that does not provide depth information corresponding to the amplitude image, or an SL or ToF sensor that provides depth information corresponding to the amplitude image.

### FIELD

The field relates generally to image processing, and more particularly to techniques for generating depth images.

### BACKGROUND

Depth images are commonly utilized in a wide variety of machine vision applications including, for example, gesture recognition systems and robotic control systems. A depth image may be generated directly using a depth imager such as a structured light (SL) camera or a time of flight (ToF) camera. Such cameras can be configured to provide both depth information and amplitude information, in the form of respective depth and amplitude images. However, the depth information provided by these and other depth imagers is often incomplete, noisy, distorted or of insufficient resolution for a particular application. Other types of imagers, such as infrared imagers, typically provide only amplitude images. Accordingly, a need exists for improved techniques for generating depth images, both in the case of depth imagers such as SL or ToF cameras as well as in infrared imagers and other imagers that do not ordinarily provide depth information.

### SUMMARY

In one embodiment, an image processing system comprises an image processor having image processing circuitry and an associated memory. The image processor is configured to identify a region of interest in an amplitude image, to detect one or more relatively low gradient regions in the region of interest, to reconstruct depth information for said one or more relatively low gradient regions, to extend the reconstructed depth information beyond said one or more relatively low gradient regions to additional pixels of the region of interest, and to generate a depth image utilizing at least portions of the reconstructed depth information and the extended reconstructed depth information.

By way of example only, the image processor may be implemented in a depth imager such as an SL or ToF camera. It is also possible to utilize the image processor to implement a depth imager using an image sensor that does not ordinarily provide depth information, such as an active lighting infrared image sensor. The image processor can be implemented in a wide variety of other types of processing devices.

Illustrative embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system that includes an image processor comprising a depth reconstruction module in an illustrative embodiment.

FIG. 2 is a block diagram of an image processing system in which an image processor comprising a depth reconstruction module is implemented within a depth imager in another illustrative embodiment.

FIG. 3 is a flow diagram of an illustrative embodiment of a depth reconstruction process implemented in the image processors of FIGS. 1 and 2.

### DETAILED DESCRIPTION

Embodiments of the invention will be illustrated herein in conjunction with exemplary image processing systems that include image processors configured to generate depth maps or other types of depth images suitable for use in gesture recognition and other applications. It should be understood, however, that embodiments of the invention are more generally applicable to any image processing system or associated device or technique that involves generating a depth image using depth information at least a portion of which is reconstructed from at least one amplitude image.

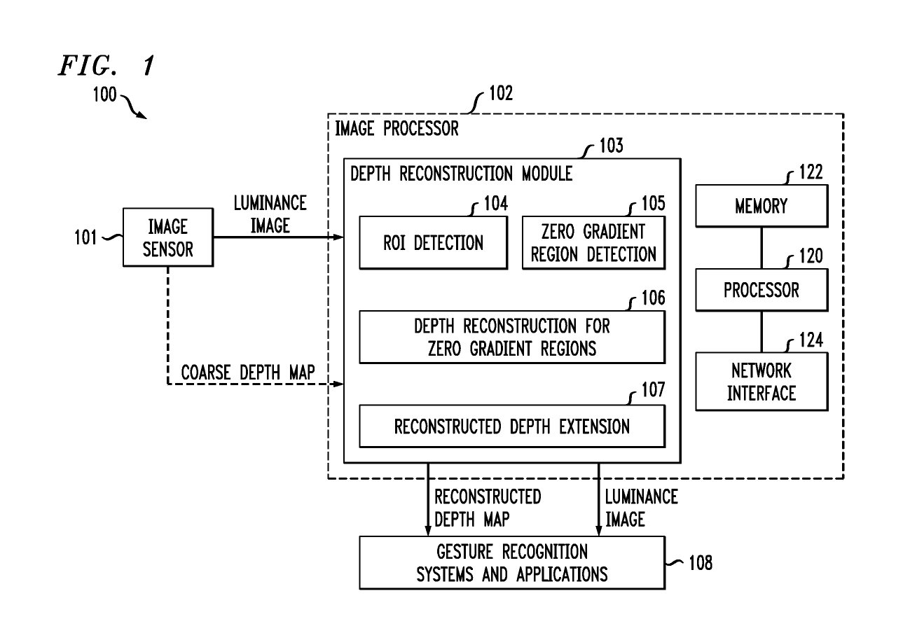

FIG. 1 shows an image processing system 100 in an illustrative embodiment of the invention. The image processing system 100 comprises an image sensor 101 coupled to an image processor 102. The image processor 102 comprises a depth reconstruction module 103 that is itself comprised of multiple modules. More particularly, the depth reconstruction module 103 includes exemplary modules 104, 105, 106 and 107 for region of interest (ROI) detection, zero gradient region detection, depth reconstruction for zero gradient regions, and reconstructed depth extension, respectively.

The ROI detection module 104 is configured to identify an ROI in a luminance image received from the image sensor 101, which may comprise an active lighting image sensor configured to provide a luminance image. The luminance image is typically in the form of a rectangular matrix of picture elements or “pixels” having respective positive integer or floating values, although other image formats could be used.

In other embodiments, other types of intensity images or more generally amplitude images may be used. The term “amplitude image” as used herein is intended to be broadly construed so as to encompass a luminance image, intensity image or other type of image providing amplitude information. As noted above, such amplitude information for a given amplitude image is typically arranged in the form of a rectangular array of pixels. The depth reconstruction module 103 is configured to reconstruct depth information from such a luminance image or other amplitude image, and in this embodiment more particularly from a luminance image provided by the image sensor 101, possibly in combination with a corresponding coarse depth map or other depth image, as will be described in more detail below.

By way of example, the image sensor 101 may comprise an active lighting image sensor such as an SL or ToF image sensor that produces both amplitude and depth information, or an active lighting infrared image sensor that produces only amplitude information. A wide variety of other types of image sensors providing different types of image output at fixed or variable frame rates can also be used.

The zero gradient region detection module 105 is configured to detect one or more regions within the ROI that have gradients sufficiently close to zero gradients. Such regions are more generally referred to herein as “relatively low gradient regions” of the ROI in that these regions have gradients that are closer to zero gradients than other regions of the ROI. Although the present embodiment identifies regions that have substantially zero gradients, other embodiments can use other types of relatively low gradient regions. For example, relatively low gradient regions can be identified as regions having respective gradients that are at or below a specified gradient threshold, where the threshold is a non-zero threshold. Accordingly, it is to be appreciated that references herein to zero gradients are exemplary only, and other embodiments can be implemented using other types of relatively low gradients.

The depth reconstruction for zero gradient regions module 106 is configured to reconstruct depth information for the zero gradient regions detected by module 105, but not for other portions of the ROI, such as those portions that have relatively high gradients. Thus, in the present embodiment, the depth reconstruction module 103 reconstructs depth information for only the zero gradient regions of the ROI.

The reconstructed depth extension module 107 is configured to extend the reconstructed depth information generated by module 106 beyond the zero gradient regions to additional pixels of the ROI.

The output of the depth reconstruction module 103 in the present embodiment comprises a depth image illustratively in the form of a reconstructed depth map generated utilizing at least portions of the reconstructed depth information generated by module 106 and the extended reconstructed depth information generated by module 107. The original luminance image is also output by the module 103 in this embodiment. The reconstructed depth map and the luminance image are provided as inputs to gesture recognition systems and applications 108, which may be implemented on one or more other processing devices coupled to or otherwise associated with the image processor 102. In other embodiments, at least portions of the gesture recognition systems and applications 108 can be implemented on the image processor 102, rather than on an associated separate processing device.

The gesture recognition systems and applications 108 are illustratively configured to recognize particular gestures utilizing reconstructed depth maps and corresponding luminance images supplied by the image processor 102 and to take appropriate actions based on the recognized gestures. For example, a given gesture recognition system can be configured to recognize a gesture from a specified gesture vocabulary and to generate a corresponding gesture pattern identifier (ID) and possibly additional related parameters for delivery to one or more of the applications. A given such application can translate that information into a particular command or set of commands to be executed by that application. The gesture recognition system may comprise, for example, separate subsystems or recognition modules for static pose recognition, dynamic gesture recognition and cursor gesture recognition.

As indicated previously, the depth reconstruction module 103 in some implementations of the FIG. 1 embodiment also utilizes an input depth map provided by the image sensor 101, via the dashed arrow in the figure, as a supplement to the luminance image in order to facilitate detection of the ROI in module 104. For example, such an input depth map can be provided in embodiments that include an image sensor that is configured to utilize SL or ToF imaging techniques. This input depth map is an example of what is more generally referred to herein as a “coarse depth map” or still more generally as a “coarse depth image” because it typically has a substantially lower resolution than the reconstructed depth map generated at the output of the depth reconstruction module 103.

In an implementation in which the coarse depth map is utilized, the ROI is detected in module 104 using both the luminance image and the coarse depth map. Moreover, the output reconstructed depth map in such an embodiment may be generated in module 103 by combining the coarse depth map with a reconstructed depth map that is generated utilizing at least portions of the reconstructed depth information generated by module 106 and the extended reconstructed depth information generated by module 107.

It should be noted that the term “depth image” as broadly utilized herein may in some embodiments encompass an associated amplitude image. Thus, a given depth image may comprise depth information as well as corresponding amplitude information. For example, the amplitude information may be in the form of a grayscale image or other type of intensity image that is generated by the same image sensor 101 that generates the depth information. An amplitude image of this type may be considered part of the depth image itself, or may be implemented as a separate image that corresponds to or is otherwise associated with the depth image. Other types and arrangements of depth images comprising depth information and having associated amplitude information may be generated in other embodiments.

Accordingly, references herein to a given depth image should be understood to encompass, for example, an image that comprises depth information only, as well as an image that comprises a combination of depth and amplitude information. The depth and amplitude images mentioned previously in the context of the description of depth reconstruction module 103 therefore need not comprise separate images, but could instead comprise respective depth and amplitude portions of a single image. An “amplitude image” as that term is broadly used herein comprises amplitude information and possibly other types of information, and a “depth image” as that term is broadly used herein comprises depth information and possibly other types of information.

It should be understood that the particular functional modules 103, 104, 105, 106 and 107 utilized in image processor 102 in the FIG. 1 embodiment are exemplary only, and other embodiments of the invention can be configured using other arrangements of additional or alternative modules or other components.

The image processor 102 in the present embodiment is assumed to be implemented using at least one processing device and comprises a processor 120 coupled to a memory 122. The processor 120 executes software code stored in the memory 122 in order to control the performance of image processing operations.

The image processor 102 also comprises a network interface 124 that supports communication over one or more networks. The network interface 124 may comprise one or more conventional transceivers. Accordingly, the image processor 102 is assumed to be configured to communicate with a computer or other processing device of the image processing system 100 over a network or other type of communication medium. Depth images generated by the image processor 102 can be provided to other processing devices for further processing in conjunction with implementation of functionality such as gesture recognition. Such depth images can additionally or alternatively be displayed, transmitted or stored using a wide variety of conventional techniques.

In other embodiments, the image processor 102 need not be configured for communication with other devices over a network, and in such embodiments the network interface 124 may be eliminated.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination. A “processor” as the term is generally used herein may therefore comprise portions or combinations of a microprocessor, ASIC, FPGA, CPU, ALU, DSP or other image processing circuitry.

As noted above, the memory 122 stores software code for execution by the processor 120 in implementing portions of the functionality of image processor 102, such as one or more of the modules 104, 105, 106 and 107 of the depth reconstruction module 103. A given such memory that stores software code for execution by a corresponding processor is an example of what is more generally referred to herein as a computer-readable storage medium having computer program code embodied therein, and may comprise, for example, electronic memory such as random access memory (RAM) or read-only memory (ROM), magnetic memory, optical memory, or other types of storage devices in any combination.

Articles of manufacture comprising such computer-readable storage media are considered embodiments of the invention. The term “article of manufacture” as used herein should be understood to exclude transitory, propagating signals.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of gesture-based system that processes image streams in order to recognize user gestures. The disclosed techniques can be similarly adapted for use in a wide variety of other systems requiring a gesture-based human-machine interface, and can also be applied to other applications, such as machine vision systems in robotics and other industrial applications that utilize gesture recognition.

It should be noted that embodiments of the invention are not limited to use in recognition of hand gestures, but can be applied to other types of gestures as well. The term “gesture” as used herein is therefore intended to be broadly construed. Moreover, depth images generated by an image processor in the manner disclosed herein are also suitable for use in a wide variety of applications other than gesture recognition.

The image processor 102 in some embodiments may be implemented on a common processing device with a computer, mobile phone or other device that processes images. By way of example, a computer or mobile phone may be configured to incorporate the image sensor 101 and the image processor 102, as well as at least portions of the gesture recognition systems and applications 108.

It is also to be appreciated that the image processor 102 may itself comprise multiple distinct processing devices, such that different portions of the depth reconstruction module 103 are implemented using two or more processing devices.

Accordingly, the particular arrangement of components shown in image processor 102 in the FIG. 1 embodiment can be varied in other embodiments. For example, an otherwise conventional image processing integrated circuit or other type of image processing circuitry suitably modified to perform processing operations as disclosed herein may be used to implement at least a portion of one or more of the modules 103, 104, 105, 106 and 107 of image processor 102. One possible example of image processing circuitry that may be used in one or more embodiments of the invention is an otherwise conventional graphics processor suitably reconfigured to perform functionality associated with one or more of the modules 103, 104, 105, 106 and 107.

Also, the particular number of modules can be varied in other embodiments. For example, in other embodiments two or more of these modules may be combined into a lesser number of modules, or the disclosed depth reconstruction and depth image generation functionality may be distributed across a greater number of modules.

The term “image processor” as used herein is intended to be broadly construed so as to encompass these and other arrangements.

The image sensor 101 and image processor 102 may be implemented within a depth imager configured to generate both depth and amplitude images, although other implementations may be used in other embodiments.

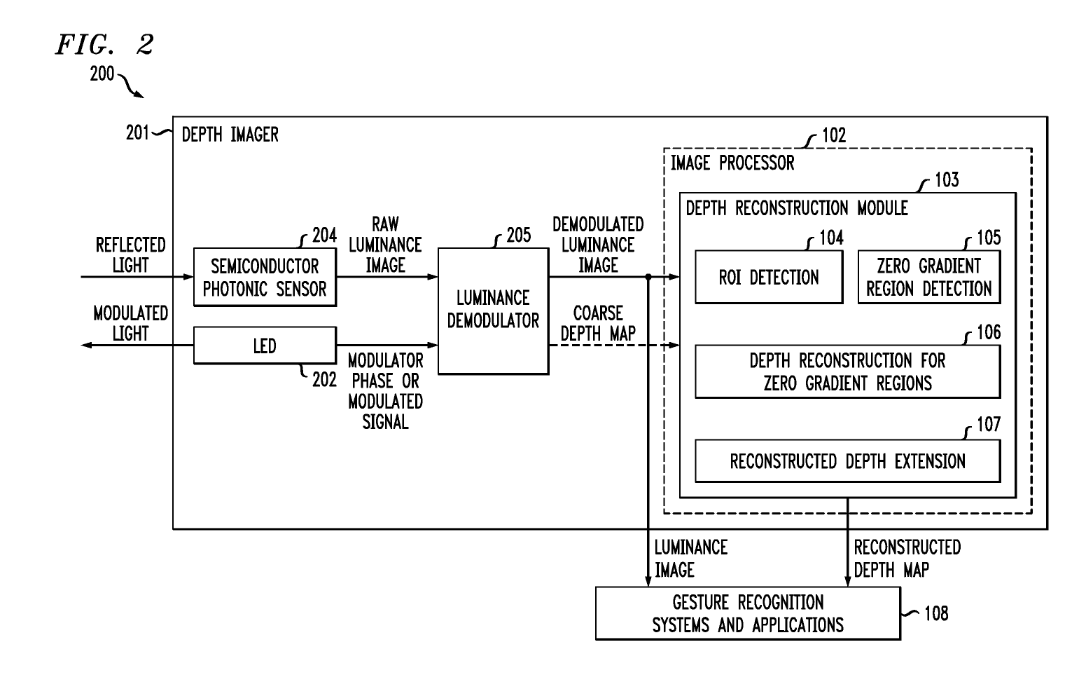

An illustrative embodiment in which the image processor 102 is implemented within an exemplary depth imager is shown in FIG. 2. In this embodiment, an information processing system 200 comprises a depth imager 201 coupled to previously-described gesture recognition systems and applications 108. The depth imager 201 incorporates the image processor 102 comprising depth reconstruction module 103 having component modules 104, 105, 106 and 107, also as previously described.

The depth imager 201 in the FIG. 2 embodiment comprises a light emitting diode (LED) emitter 202 that generates modulated light for imaging a scene. The LED emitter 202 may comprise an array of LEDs or a single LED. The modulated light illustratively comprises, for example, infrared light, although other types of light sources may be used. The corresponding reflected light is detected by a semiconductor photonic sensor 204 that produces a raw luminance image. The raw luminance image is applied to a luminance demodulator 205 along with the modulated signal from LED emitter 202 or the corresponding modulator phase information. The luminance demodulator 205 processes these inputs to generate the demodulated luminance image, and possibly an associated coarse depth map, which are applied as respective inputs to the depth reconstruction module 103 of image processor 102.

By way of example, in an active lighting infrared image sensor implementation of the FIG. 2 embodiment, the luminance demodulator 205 comprises a shutter synchronized with the modulation of the LED emitter 202, such that the shutter is open for a short period of time corresponding to the LED emitter being in its “on” state. Such an arrangement generally does not provide an associated coarse depth map, and therefore the reconstructed depth map generated by depth reconstruction module 103 is generated entirely by reconstruction of depth information from the luminance image.

As another example, in an implementation utilizing ToF depth sensing, the luminance demodulator is more particularly configured as a ToF demodulator which reconstructs both the amplitude and the phase of the reflected light and converts the phase to per-pixel coarse depth information which collectively provides the coarse depth map. In this case, the reconstructed depth map is generated by the depth reconstruction module 103 using not only the luminance image but also the coarse depth map.

Other types of image sensing techniques can be used, providing at least a luminance image or other type of amplitude image and possibly an associated depth map or other type of depth image, for further processing by the depth reconstruction module 103.

It is therefore apparent that embodiments of the invention allow a depth image to be generated without requiring the use of a depth image sensor.

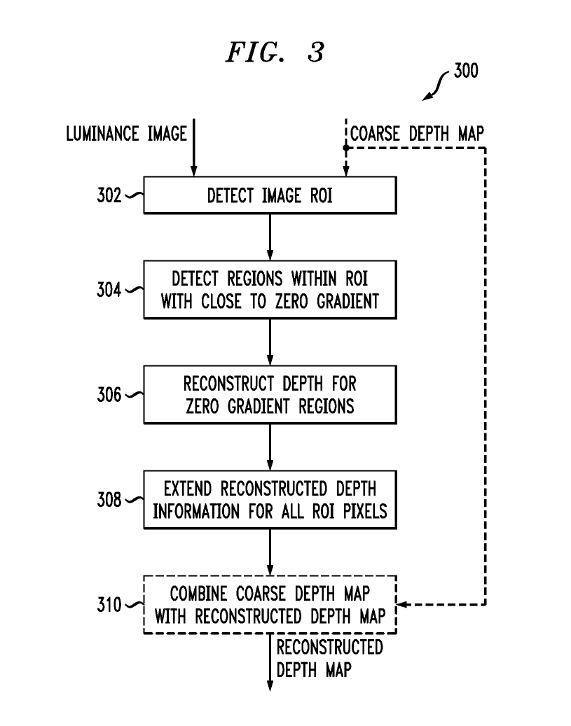

The operation of the depth reconstruction module 103 of image processor 102 in the image processing system embodiments of FIGS. 1 and 2 will now be described in greater detail with reference to FIG. 3. This figure illustrates an exemplary process 300 that is implemented in the image processor 102 using depth reconstruction module 103. The process 300 includes steps 302 through 310 as shown, with steps 302, 304, 306 and 308 being performed by respective modules 104, 105, 106 and 107 of the depth reconstruction module 103, and step 310 being performed by one or more other components of the image processor 102. As indicated previously, portions of the process may be implemented at least in part utilizing software executing on image processing circuitry of the image processor 102.

The process 300 is applied to a given luminance image and possibly also utilizes a corresponding coarse depth map if available. Such exemplary amplitude and depth images may be subject to various preprocessing operations such as filtering and noise reduction prior to application of the steps of process 300.

In step 302, an ROI is detected in the luminance image. Detection of the ROI in step 302 may also make use of a coarse depth map, if available. This step in the present embodiment more particularly involves defining an ROI mask for a region in the luminance image that corresponds to one or more hands of a user in an imaged scene, also referred to as a hand region of the luminance image. The output of the ROI detection step 302 in the present embodiment includes a binary ROI mask for the hand region in the input luminance image. It can be in the form of an image having the same size as the input luminance image, or a sub-image containing only those pixels that are part of the ROI.

For further description below, it is assumed that the binary ROI mask is an image having the same size as the input luminance image. Thus, by way of example, if the input luminance image comprises an H×W matrix of pixels, the binary ROI mask generated in step 302 also comprises an H×W matrix of pixels, with the pixels within the ROI having a certain binary value, illustratively a logic 1 value, and pixels outside the ROI having the complementary binary value, illustratively a logic 0 value.

Amplitude values and possibly also depth values are associated with respective pixels of the ROI defined by the binary ROI mask. These ROI pixels are assumed to be part of one or more input images, such as the input luminance image.

A variety of different techniques can be used to detect the ROI in step 302. For example, it is possible to use techniques such as those disclosed in Russian Patent Application No. 2013135506, filed Jul. 29, 2013 and entitled “Image Processor Configured for Efficient Estimation and Elimination of Background Information in Images,” which is commonly assigned herewith and incorporated by reference herein.

As another example, the binary ROI mask can be determined using threshold logic applied to pixel values of the input luminance image. More particularly, one can select only those pixels with luminance values greater than some predefined threshold. For active lighting imagers such as SL or ToF imagers or active lighting infrared imagers, the closer an object is to the imager, the higher the luminance values of the corresponding image pixels, not taking into account reflecting materials. Accordingly, selecting only those pixels with relatively high luminance values for the ROI allows one to preserve close objects from an imaged scene and to eliminate far objects from the imaged scene.

It should be noted that for ToF imagers, pixels with lower luminance values tend to have higher error in their corresponding depth values, and so removing pixels with low luminance values from the ROI additionally protects one from using incorrect depth information.

In embodiments in which the coarse depth map is available in addition to the luminance image, the ROI can be detected at least in part by selecting only those pixels with depth values falling between predefined minimum and maximum threshold depths Dmin and Dmax. These thresholds are set to appropriate distances between which the hand region is expected to be located within the image. For example, the thresholds may be set as Dmin=0, Dmax=0.5 meters (m), although other values can be used.

In conjunction with detection of the ROI, opening or closing morphological operations utilizing erosion and dilation operators can be applied to remove dots and holes as well as other spatial noise in the image. Other exemplary noise reduction techniques that may be utilized in conjunction with detection of the ROI are described in PCT International Application PCT/US13/56937, filed on Aug. 28, 2013 and entitled “Image Processor With Edge-Preserving Noise Suppression Functionality,” which is commonly assigned herewith and incorporated by reference herein.

One possible implementation of a threshold-based ROI determination technique using both amplitude and depth thresholds is as follows:

1. Set ROIᵢⱼ=0 for each i and j.

2. For each depth pixel dᵢⱼ set ROIᵢⱼ=1 if dᵢⱼ≧dₘᵢₙ and dᵢⱼ≦dₘₐₓ.

3. For each amplitude pixel aᵢⱼ set ROIᵢⱼ=1 if aᵢⱼ≧aₘᵢₙ.

4. Coherently apply an opening morphological operation comprising erosion followed by dilation to both ROI and its complement to remove dots and holes comprising connected regions of ones and zeros having area less than a minimum threshold area Aₘᵢₙ.

It is also possible in some embodiments to detect a palm boundary and to remove from the ROI any pixels below the palm boundary, leaving essentially only the palm and fingers in a modified hand image. Such a step advantageously eliminates, for example, any portions of the arm from the wrist to the elbow, as these portions can be highly variable due to the presence of items such as sleeves, wristwatches and bracelets, and in any event are typically not useful for hand gesture recognition.

Exemplary techniques suitable for use in implementing the above-noted palm boundary determination in the present embodiment are described in Russian Patent Application No. 2013134325, filed Jul. 22, 2013 and entitled “Gesture Recognition Method and Apparatus Based on Analysis of Multiple Candidate Boundaries,” which is commonly assigned herewith and incorporated by reference herein.

Alternative techniques can be used. For example, the palm boundary may be determined by taking into account that the typical length of the human hand is about 20-25 centimeters (cm), and removing from the ROI all pixels located farther than a 25 cm threshold distance from the uppermost fingertip, possibly along a determined main direction of the hand. The uppermost fingertip can be identified simply as the uppermost 1 value in the binary ROI mask.

It should be appreciated, however, that palm boundary detection need not be applied in determining the binary ROI mask in step 302. For example, in embodiments in which the detected ROI comprises a pair of hands of a given user, the above-described palm boundary detection can be eliminated.

In step 304, one or more regions having a close to zero gradient within the detected ROI are determined. A region having a “close to zero” gradient is an example of what is more generally referred to herein as a “relatively low gradient region” in that it exhibits a substantially lower gradient than other portions of the detected ROI. For example, it may comprise a portion, area or other region of the ROI that has a gradient at or below a specified gradient threshold, or a region of the ROI that has a substantially zero gradient. The latter is also referred to herein as a zero gradient region, although it is to be appreciated that the gradient need not be exactly zero. In these and other relatively low gradient regions, it is assumed for purposes of the process 300 that hand surface is primarily locally perpendicular to the direction from the imager and therefore most incident light is reflected back to the image sensor. As a result, there is a strong dependency in such regions between the luminance value for a given pair of pixel index coordinates and depth to the corresponding point on the hand.

An exemplary technique for detecting regions within the ROI with close to zero gradient in step 304 will now be described. First, it is assumed that the detection of the ROI in step 302 involves smoothing the input luminance image. More particularly, input luminance image A is smoothed using a low-pass filter or other type of filter configured to suppress speckle noise in the input luminance image A. For example, a Gaussian filter with σ=3 may be used. Let Â be the smoothed luminance image. It is further assumed that the ROI in step 302 is detected in this smoothed luminance image. The binary ROI mask generated in step 302 is therefore generated using the smoothed luminance image Â. Alternatively, the input luminance image A may be applied as an input not only to step 302 but also as an input to step 304, with the ROI being detected in the input luminance image A in step 302 and the smoothed luminance image Â being generated in step 304 separately from the ROI detection.

The exemplary technique for detecting regions with close to zero gradient includes the following steps:

Step 1. For each pixel (i,j) (i>1, j>1) within the ROI determined in step 302, estimate luminance gradient dÂ(i,j) as dÂ(i,j)=(Â(i,j)−Â(i,j−1), Â(i,j)−Â(i−1,j)). Other types of gradient estimation may be used.

Step 2. Initialize an H×W zero gradient binary matrix G with zeros. For all pixels (i,j) from the ROI, set G(i,j) to 1 if abs(dÂ(i,j)₁)≦Athresh1 and abs(dÂ(i,j)₂≦Athresh1, where abs denotes absolute value and where Athresh1 is a positive small threshold having a value that significantly depends on an average value of luminance for a typical scene. The value of Athresh1 is sufficiently small to ensure selection of only those regions corresponding to surfaces substantially perpendicular to the direction to the image sensor.

Step 3. For each pixel (i,j) from the ROI for which G(i,j)=0 but there exists at least one neighboring pixel (i1,j1) for which G(i1,j1)=1, if abs(Â(i,j)−Â(i1,j1))<Athresh2 then set G(i,j)=1, where i−1≦i1≦i+1 and j−1≦j+j1≦j+1. The value of threshold Athresh2 is also a small positive threshold having substantially the same order as the value of Athresh1. This step is repeated for multiple passes, and more particularly for k passes, where a suitable value for k in some embodiments is k=3. Such multiple passes ensure that the initial zero gradient areas are extended to encompass adjacent pixels having sufficiently close luminance values.

In step 306, depth information is reconstructed from the luminance values for the zero gradient regions identified in step 304. This step can be configured to assume that for small surfaces with homogeneous reflective characteristics which are oriented perpendicular to the image sensor direction, luminance is approximately inversely proportional to the square of distance to the corresponding surface, if the position of that surface within the frame and therefore lighting angle for that surface does not change. In this fixed position scenario, the relationship between luminance and depth for pixel (i,j) can be expressed as A(i,j)˜K/d²(i,j), where K denotes a coefficient that can be experimentally determined by taking into account the particular type of image sensor used and other implementation-specific factors.

Additionally or alternatively, if the surface position and therefore lighting angle is instead assumed to change, a similar dependency between luminance and depth is observed, but is more particularly modeled in this scenario as A(i,j)˜K(r)/d²(i,j) where r=sqrt((i−i0)²+(j-j0)²) denotes pixel distance from frame center (i0,j0). For the assumed frame dimension H×W, i0=(H−1)/2 and j0=(W−1)/2). It has been observed that dependency between luminance and the inverse square of depth for different values of r is approximately linear. Non-linear dependency for small depth values is attributed to luminance saturation effects.

In determining the coefficient function K(r), the distribution of light from the active lighting imager should be taken into account. For example, position of an LED lighting source relative to the corresponding image sensor is typically an implementation-specific factor that should be taken into account in determining K(r). Also, relative luminance value as a function of radiation angle is often known for various types of LED sources and can be used in determining K(r) in a given embodiment.

As a more particular example, in an embodiment with a single infrared LED source, a luminance value A(α) for a given radiation angle a can be approximated as A₀*cos(α) where A₀ is the luminance value at the same distance for α=0. It can be shown that for this case the coefficient function can be approximated as K(r)=c/sqrt(sqrt(1+4*r²/W²)) where c is a positive constant. In the case of more complex LED sources such as arrays of multiple LEDs, a more complex approximation of K(r) can be used.

In these and other cases, the coefficient function K(r) can be determined at least in part by applying a calibration process to the particular imager configuration. Such a calibration process can be implemented using the following steps:

Step 1. An image of a plane surface with reflecting characteristics close to those of human skin is acquired by the image sensor so that depth information for each pixel is simultaneously measured with the luminance information. Multiple measurements of this kind are made for each pixel (i,j), i=0 . . . H−1, j=0 . . . W−1.

Step 2. For each value of r=0 . . . sqrt((W/2)²+(H/2)²), depth and luminance information for pixels (i,j) is collected, where as indicated previously r=sqrt((i−i0)²+(j−j0)²). Using least means squared (LMS) or other regression-like techniques, a particular coefficient of linear dependency between depth value d and sqrt(1/A) is estimated. Each such coefficient is an element of the coefficient function K(r) for a particular value of r.

Step 3. The coefficient function K(r) is approximated using a polynomial of fixed degree (e.g., 3) or other similar function.

Using the foregoing calibration process, the coefficient function for an exemplary commercially-available PMD Nano image sensor was approximated as K(r)=4e−7*r³−6e−5*r²+0.00053*r+0.3.

The resulting coefficient function is then utilized in the manner previously described to reconstruct depth information from luminance information for the zero gradient regions.

In step 308, the reconstructed depth information determined for the zero gradient regions in step 306 is extended to other portions of the ROI. More particularly, in this embodiment, the reconstructed depth information is extended to substantially all of the pixels of the ROI that were not part of any of the zero gradient regions. These additional pixels in the context of the present embodiment are those pixels that are not part of the above-described zero gradient mask G.

The extension of the reconstructed depth information in step 308 can be implemented using a number of different techniques. For example, depth values for pixels that are not part of the zero gradient mask G can be defined as a mean or other function of the depth values of the pixels that are part of the zero gradient mask G. A low-pass filter or other type of filter can then be used to smooth the resulting reconstructed depth map. In one embodiment, a Gaussian filter is used that has a smoothing factor sufficient to make depth transitions between pixels in G and pixels not in G smaller than a designated depth measurement precision. For the above-noted PMD Nano image sensor, a smoothing factor of σ=10 was utilized. In generating the reconstructed depth map, depth values for pixels within the ROI but not part of the zero gradient mask G are replaced with the corresponding smoothed depth values.

Another exemplary technique for extension of the reconstructed depth information in step 308 is as follows. It is assumed in this technique that curvature at the edges of a human hand follows a function δ(dist), where dist is distance between a given reconstructed pixel and the closest pixel in the zero gradient mask G. This distance may instead be calculated using an average distance of the given reconstructed pixel from multiple pixels in G. The function itself assumes a spherical surface having a specified radius of curvature, such as a radius of approximately 1 cm. Using this function, depth values for all pixels within the ROI but not in the zero gradient mask G are reconstructed as d₁−δ(dist), where d₁ denotes the depth value for the closest pixel (i1,j1) from G for the pixel (i,j) within the ROI but not in G, where dist is the distance between (i,j) and (i1,j1) recalculated in meters.

The above reconstructed depth extension techniques are exemplary only, and other techniques may be used to determine depth values for portions of the ROI outside of the zero gradient regions in other embodiments. All such techniques are intended to be encompassed by general references herein to “extending” or “extension of” reconstructed depth information beyond one or more zero gradient regions.

In step 310, the coarse depth map if available is combined with the reconstructed depth map from step 308 to generate an output reconstructed depth map. This combination is illustratively computed as Reconstructed_depth=(actual_depth*W1+depth_from_luminance*W2)/(W1+W2) where W1=1/σ1, W2=1/σ2 and σ1 and σ2 denote average standard deviations of actual and reconstructed depth jitter (e.g., noise). Other techniques can be used to combine the reconstructed depth map and the course depth map. In embodiments in which there is no coarse depth map available, step 310 is eliminated and the output of step 308 is utilized as the reconstructed depth map.

The particular types and arrangements of processing blocks shown in the embodiment of FIG. 3 are exemplary only, and additional or alternative blocks can be used in other embodiments. For example, blocks illustratively shown as being executed serially in the figures can be performed at least in part in parallel with one or more other blocks or in other pipelined configurations in other embodiments.

The reconstructed depth maps or other reconstructed depth images generated in the illustrative embodiments provide significantly improved gesture recognition performance relative to conventional arrangements. For example, these embodiments provide substantial improvements relative to use of a coarse depth map alone in SL or ToF camera implementations. Moreover, the disclosed techniques provide accurate and efficient generation of depth maps or other depth images in infrared imagers and other types of active lighting imagers that would not otherwise provide depth information.

The depth information in these and other embodiments can be generated at low cost, with low jitter and high precision. Accordingly, problems attributable to incomplete, noisy, distorted or poor resolution depth images provided by some conventional depth imagers are advantageously overcome. Also, capabilities of active lighting imagers are enhanced. Performance in the corresponding gesture recognition systems and applications is accelerated while ensuring a high degree of accuracy in the recognition process.

It should again be emphasized that the embodiments of the invention as described herein are intended to be illustrative only. For example, other embodiments of the invention can be implemented utilizing a wide variety of different types and arrangements of image processing circuitry, modules, processing blocks and associated operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A method comprising steps of:
identifying a region of interest in an amplitude image;
detecting one or more relatively low gradient regions in the region of interest;
reconstructing depth information for said one or more relatively low gradient regions in the region of interest;
extending the reconstructed depth information beyond said one or more relatively low gradient regions to additional pixels of the region of interest; and
generating a depth image utilizing at least portions of the reconstructed depth information and the extended reconstructed depth information;
wherein the steps are implemented in an image processor comprising a processor coupled to a memory.

2. The method of claim 1 wherein said one or more relatively low gradient regions comprise regions having respective gradients at or below a specified gradient threshold.

3. The method of claim 1 wherein said one or more relatively low gradient regions comprise regions having respective substantially zero gradients.

4. The method of claim 1 wherein identifying a region of interest comprises generating a binary region of interest mask in which pixels within the region of interest all have a first binary value and pixels outside the region of interest all have a second binary value complementary to the first binary value.

5. The method of claim 1 wherein reconstructing depth information for said one or more relatively low gradient regions comprises reconstructing depth information for said one or more relatively low gradient regions but not for other portions of the region of interest.

6. The method of claim 1 wherein the amplitude image comprises a luminance image generated by an active lighting imager.

7. The method of claim 6 wherein the active lighting imager comprises one of an active lighting infrared image sensor, an SL image sensor and a ToF image sensor.

8. The method of claim 1 wherein reconstructing depth information for said one or more relatively low gradient regions in the region of interest comprises:
determining at least one coefficient that relates amplitude to depth for a particular image sensor configuration; and
utilizing the coefficient to estimate one or more depth values from one or more corresponding amplitude values for respective pixels of said one or more relatively low gradient regions.

9. The method of claim 8 wherein the determined coefficient comprises an element of a coefficient function that relates amplitude to depth for a given pixel as a function of a distance between that pixel and an approximate center of an image frame in the particular image sensor configuration.

10. The method of claim 1 wherein extending the reconstructed depth information beyond said one or more relatively low gradient regions to additional pixels of the region of interest comprises computing one or more depth values for pixels outside of said one or more relatively low gradient regions as a function of depth values determined for pixels within said one or more relatively low gradient regions.

11. The method of claim 10 wherein a depth value for a given pixel outside of said one or more relatively low gradient regions is computed utilizing a mean of a plurality of depth values for respective pixels within said one or more relatively low gradient regions.

12. The method of claim 1 wherein identifying a region of interest comprises identifying the region of interest utilizing the amplitude image and a corresponding coarse depth image.

13. The method of claim 1 wherein generating a depth image utilizing at least portions of the reconstructed depth information and the extended reconstructed depth information further comprises:
generating a reconstructed depth image comprising at least portions of the reconstructed depth information and the extended reconstructed depth information; and
combining a coarse depth image with the reconstructed depth image.

14. An article of manufacture comprising a computer-readable storage medium having computer program code embodied therein, wherein the computer program code when executed in the image processor causes the image processor to perform the method of claim 1.

15. An apparatus comprising:
an image processor adapted for coupling to an image sensor;
the image processor comprising image processing circuitry and an associated memory;
wherein the image processor is configured:
to identify a region of interest in an amplitude image;
to detect one or more relatively low gradient regions in the region of interest;
to reconstruct depth information for said one or more relatively low gradient regions in the region of interest;
to extend the reconstructed depth information beyond said one or more relatively low gradient regions to additional pixels of the region of interest; and
to generate a depth image utilizing at least portions of the reconstructed depth information and the extended reconstructed depth information.

16. An integrated circuit comprising the apparatus of claim 15.

17. An imager comprising:
an image sensor; and
an image processor coupled to the image sensor;
wherein the image processor is configured:
to identify a region of interest in an amplitude image;
to detect one or more relatively low gradient regions in the region of interest;
to reconstruct depth information for said one or more relatively low gradient regions in the region of interest;
to extend the reconstructed depth information beyond said one or more relatively low gradient regions to additional pixels of the region of interest; and
to generate a depth image utilizing at least portions of the reconstructed depth information and the extended reconstructed depth information.

18. The imager of claim 17 wherein the image sensor comprises an active lighting infrared image sensor that does not provide depth information corresponding to the amplitude image.

19. The imager of claim 17 wherein the image sensor comprises an SL or ToF image sensor that provides depth information corresponding to the amplitude image.

20. An image processing system comprising the imager of claim 17.
